(19) United States
(12) Patent Application Publication
(10) Pub. No.: US 2011/0137001 A1
(43) Pub. Date: Jun. 9, 2011

(54) COPOLYMER FOR IMPROVED DRYING

(75) Inventors: Evelyne Prat, Pantin (FR); Evelyne Prat, Pantin (FR); Oliveir Anthony, Meriel (FR); Marie-Pierre Labeau, Burlington, NJ (US); Chi-Thanh Vuong, Lognes (FR); Marc Evers, Strombeek-Bever (BE); Annick Julia Oscara Martens, Bornerm (BE); Luca Sarcinelli, Rome (IT); Stefano Scialla, Rome (IT)

(73) Assignee: Rhodia Operations, Aubervillers (FR)

(21) Appl. No.: 12/670,630

(22) PCT Filed: Jul. 22, 2008
(86) PCT No.: PCT/EP08/59569

§ 371 Date: May 19, 2010

(30) Foreign Application Priority Data
Jul. 26, 2007 (FR) 07 05449

(51) Int. Cl. C08F 226/08

(52) U.S. Cl. 526/263

(57) ABSTRACT

The invention relates to a novel copolymer containing vinyl-pyrrolidone units. The copolymer further includes units of the betaine type. The invention further relates to the use of the copolymer in compositions for drying dishes, said polymer particularly improving the drying thereof.

A subject matter of the present invention is a novel copolymer, its process of preparation and uses of this copolymer.

During many cleaning operations, water or an aqueous composition is applied to the object to be cleaned, rinsing is optionally carried out and then drying is allowed to take place. This is the case, for example, during the cleaning of dishes by hand or during the automatic cleaning of dishes using a dishwasher. The drying phase can take a certain time and/or can leave traces of water-soluble or water-dispersible materials (for example traces of inorganic matter included in the water) and/or traces of contaminants, generally grease, originating from the object to be cleaned.

It is known to add poly(vinylpyrrolidone) (PVP) to some compositions for cleaning hard surfaces, in particular to compositions for cleaning tiled surfaces or to compositions for cleaning the surface of toilet bowls. On these ceramic surfaces, PVP makes possible drying which is rapid and noticeable: the composition may be observed to gradually leave the surface and a composition front which moves over the surface like the ebb of a wave may be observed. The term “progressive dewetting” is often used; it concerns a discharge of the water by flow rather than by evaporation. This is appreciated by the consumer, who notices the effect of the composition and/or who notices that drying is efficient. The drying obtained subsequent to the application of a composition comprising PVP is in fact fast. Discharge by flow also makes it possible to limit the traces.

However, PVP has a limited field of application: it cannot be formulated in compositions for cleaning dishes or can be formulated only with difficulty within very narrow formulation windows. This is because, in compositions for cleaning dishes, which generally have significant charges of surfactants, it is poorly dispersible and/or of low stability in these compositions. It can in particular be harmful to the transparency of the compositions, while transparency is a quality desired by consumers.

The quality of the drying subsequent to the application of a composition for cleaning dishes, in particular, remains to be improved. There exists a need for compositions for cleaning dishes, in particular, which exhibit improved drying properties. There exists a need for compounds which can contribute such improvements and which can be easily formulated in compositions for cleaning dishes.

The present invention meets these needs by providing a copolymer comprising zwitterionic units A and other units B, the units A comprising a betaine group, characterized in that:
the betaine group of the units A is a sulfobetaine group, and
the units B are units deriving from vinylpyrrolidone.

The copolymer of the invention can in particular provide the following advantages to a composition for cleaning dishes:
ease of formulation of the composition,
adjustability and/or adaptability to a large number of compositions,
preservation of the transparency of the composition,
progressive dewetting, which is preferably sufficiently slow to be noticeable and/or to prevent traces,
accelerated drying,
traces left on drying absent or reduced,
drying noticeable by the consumer, in particular by observation,
combination of at least two of these advantages.

These advantages are particularly advantageous in the context of the cleaning of transparent items of the dishes, in particular made of glass or crystal. These advantages and/or the perception of these advantages can in particular be usefully communicated, in connection with the copolymer or simply in connection with the composition, by any communication means related to the product, for example on the label, in an advertisement, via a customer service department or via an Internet site.

Definitions

In the present patent application, sulfobetaine group is understood to mean a group comprising an anionic group and a cationic group, at least one of the groups comprising a sulfur atom.

In the present patent application, unit deriving from a monomer denotes, for the units other than the A_{precursor} units, a unit which can be obtained directly from said monomer by polymerization. Thus, for example, a unit deriving from an acrylic or methacrylic acid ester does not cover a unit of formula —CH₂—CH(COOH)—, —CH₂—C(CH₃)(COOH)— or —CH₂—CH(OH)—, respectively, for example obtained by polymerizing an acrylic or methacrylic acid ester or vinyl acetate, respectively, and by then hydrolyzing. A unit deriving from acrylic or methacrylic acid covers, for example, a unit obtained by polymerizing a monomer (for example an acrylic or methacrylic acid ester) and by then reacting (for example by hydrolysis) the polymer obtained so as to obtain units of formula —CH₂—CH(COOH)— or —CH₂—C(CH₃)(COOH)—. A unit deriving from a vinyl alcohol covers, for example, a unit obtained by polymerizing a monomer (for example a vinyl ester) and by then reacting (for example by hydrolysis) the polymer obtained so as to obtain units of formula —CH₂—CH(OH)—. Units deriving from a monomer A may, for example, have been obtained by polymerization of monomers A_{precursor} followed by a postpolymerization reaction in order to obtain units comprising the betaine group. The units A are not regarded as units deriving from monomers A_{precursor} not comprising a betaine group.

In the present patent application, unless otherwise indicated, when reference is made to molar mass, it will relate to the absolute weight-average molar mass, expressed in g/mol. This can be determined by aqueous gel permeation chromatography (GPC), by light scattering (DLS or MALLS for an aqueous eluent), with an aqueous eluent or an organic eluent (for example formamide), according to the composition of the polymer.

In the present patent application, unless otherwise mentioned, the amounts and proportions are indicated as active material (in contrast to diluted or dispersed material) and by weight.

Copolymer

The copolymer of the invention comprises zwitterionic units A and other units B, the units A comprising a betaine group, characterized in that:
the betaine group of the units A is a sulfobetaine group, and
the units B are units deriving from vinylpyrrolidone.

It is preferably a random copolymer.

According to a preferred form, the units A and B, with optionally other units, form a polyalkylene hydrocarbon chain optionally interrupted by one or more nitrogen or sulfur atoms.

Units A Comprising a Sulfobetaine Group

The betaine group of the units A comprises an anionic group and a cationic group, at least one of the groups comprising a sulfur atom. The anionic group can in particular be a carbonate group, a sulfur-comprising group, such as a sulfonate group, a phosphorus-comprising group, such as a phosphate, phosphonate or phosphinate group, or an ethenolate group. Preferably, it is a sulfonate group. The cationic group can be an onium group or an inium group of the nitrogen, phosphorus or sulfur family, for example an ammonium, pyridinium, imidazolinium, phosphonium or sulfonium group. Preferably, it is an ammonium group (preferably a quaternary ammonium group). Advantageously, the betaine group is a sulfobetaine group comprising a sulfonate group and a quaternary ammonium group. It should be noted that it would not be departing from the scope of the invention to combine several different betaine groups, by combining several different units A in the copolymer.

The betaine groups are typically pendant groups of the copolymer, typically obtained from monomers comprising at least one ethylenic unsaturation.

Within the units A, the number of positive charges is equal to the number of negative charges. The units A are electrically neutral, in at least one pH range.

Useful betaine groups can be represented, in the case of the cations of the nitrogen family, by the following formulae (I) to (IV), exhibiting a cationic charge at the center of the functional group and an anionic charge at the end of the functional group:

—N⁽⁺⁾(R¹)(R²)—R-A-O⁽⁻⁾ (I)

—(R³)C═N⁽⁺⁾(R⁴)—R-A-O⁽⁻⁾ (II)

—(R³)(R)C—N⁽⁺⁾(R⁴)(R⁵)—R-A-O⁽⁻⁾ (III)

—N⁽⁺⁾(═R⁶)—R-A-O⁽⁻⁾ (IV)
in which formulae (I) to (IV):
   the symbols R¹, R² and R⁵, which are alike or different, represent an alkyl radical comprising from 1 to 7 carbon atoms, preferably 1 or 2 carbon atoms,
   the symbols R³ and R⁴ represent hydrocarbon radicals forming, with the nitrogen atom, a nitrogenous heterocycle optionally comprising one or more other heteroatoms, in particular of nitrogen,
   the symbol R⁶ represents a hydrocarbon radical forming, with the nitrogen atom, a saturated or unsaturated nitrogenous heterocycle optionally comprising one or more other heteroatoms, in particular of nitrogen,
   the symbol R represents a linear or branched alkylene radical comprising from 1 to 15 carbon atoms, preferably from 2 to 4 carbon atoms, optionally substituted by one or more hydroxyl groups, or a benzylene radical,
   the symbol A represents S(═O)(═O).

In the case of cations of the phosphorus family, mention may be made of the betaine groups of formula (VI):

—P⁽⁺⁾(R¹)(R²)—R-A-O⁽⁻⁾ (VI)
in which formula (VI) the symbols R¹, R², R and A have the definitions given above.

In the case of cations of the sulfur family, mention may be made of the betaine groups of formulae (VIII) and (IX):

—S⁽⁺⁾(R¹)—R-A-O⁽⁻⁾ (VIII)

—R-A′(-O⁽⁻⁾)—R—S⁽⁻⁾(R¹)(R²) (IX)
in which formula (VIII) the symbols R¹ and R have the definitions given above and the symbol A represents S(═O)(═O), OP(═O)(═O), OP(═O)(OR′), P(═O)(OR′) or P(═O)(R′), where R′ represents an alkyl radical comprising from 1 to 7 carbon atoms or a phenyl radical,
in which formula (IX):
   the symbols R¹, R² and R have the definitions given above,
   the symbol A′ represents —O—P(═O)—O—.

The betaine groups can be connected to the carbon atoms of a macromolecular chain deriving from the polymerization of an ethylenic unsaturation (skeleton, backbone) of the copolymer via in particular a divalent or polyvalent hydrocarbon unit (for example an alkylene or arylene unit), optionally interrupted by one or more heteroatoms, in particular of oxygen or of nitrogen, an ester unit or an amide unit, or else by a valence bond.

The copolymer can in particular be obtained by radical polymerization
of monomers A comprising an ethylenically unsaturated betaine group, in particular of ethylenically unsaturated monomers carrying at least one betaine group with formulae given above,
and of vinylpyrrolidone, from which the units B derive.

Said monomers A can exhibit, by way of example:
one or more mono- or polyethylenically unsaturated hydrocarbon radicals (in particular vinyl, allyl or styryl radicals, and the like),
one or more mono- or polyethylenically unsaturated ester radicals (in particular acrylate, methacrylate or maleate radicals, and the like), and/or
one or more mono- or polyethylenically unsaturated amide radicals (in particular acrylamide or methacrylamide radicals, and the like).

The units A can derive from at least one betaine monomer A selected from the group consisting of the following monomers:
alkylsulfonates of dialkylammonioalkyl acrylates or methacrylates, -acrylamides or -methacrylamides, such as:
   sulfopropyldimethylammonioethyl methacrylate, sold by Raschig under the name SPE:

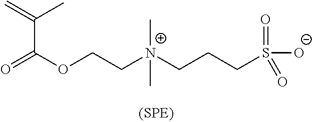

sulfoethyldimethylammonioethyl methacrylate and sulfobutyldimethylammonioethyl methacrylate:

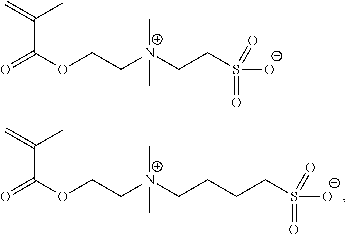

the synthesis of which is described in the paper “Sulfobetaine zwitterionomers based on n-butyl acrylate and 2-ethoxyethyl acrylate: monomer synthesis and copolymerization behavior”, Journal of Polymer Science, 40, 511-523 (2002),
sulfohydroxypropyldimethylammonioethyl methacrylate:

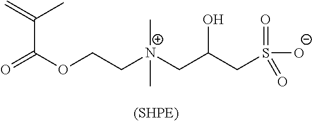

sulfopropyldimethylammoniopropylacrylamide:

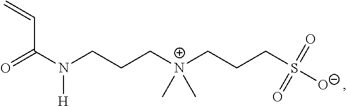

the synthesis of which is described in the paper “Synthesis and solubility of the poly(sulfobetaine)s and the corresponding cationic polymers: 1. Synthesis and characterization of sulfobetaines and the corresponding cationic monomers by nuclear magnetic resonance spectra”, Wen-Fu Lee and Chan-Chang Tsai, Polymer, 35 (10), 2210-2217 (1994),
sulfopropyldimethylammoniopropylmethacrylamide, sold by Raschig under the name SPP:

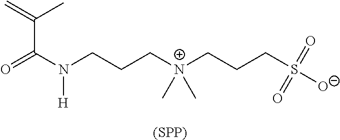

sulfopropyldimethylammonioethyl methacrylate, sold by Raschig under the name SPDA:

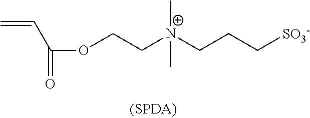

sulfohydroxypropyldimethylammoniopropylmethacrylamide:

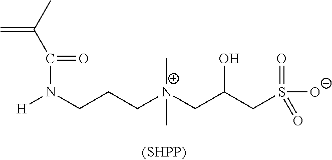

sulfopropyldiethylammonioethyl methacrylate:

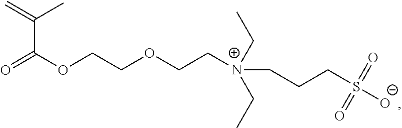

the synthesis of which is described in the paper “Poly(sulfopropylbetaines): 1. Synthesis and characterization”, V. M. Monroy Soto and J. C. Galin, Polymer, 1984, Vol. 25, 121-128,
sulfohydroxypropyldiethylammonioethyl methacrylate:

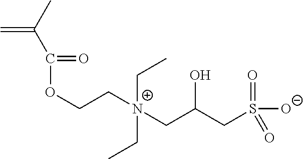

heterocyclic betaine monomers, such as:
   sulfobetaines derived from piperazine:

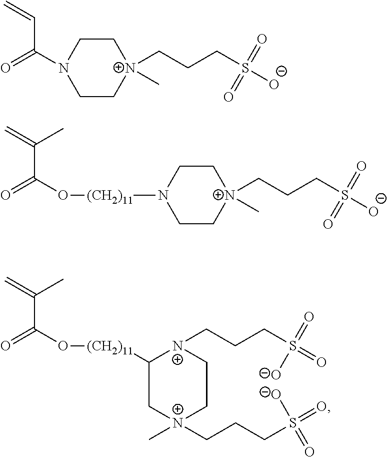

the synthesis of which is described in the paper “Hydrophobically Modified Zwitterionic Polymers: Synthesis, Bulk Properties, and Miscibility with Inorganic Salts”, P. Koberle and A. Laschewsky, Macromolecules, 27, 2165-2173 (1994),
sulfobetaines derived from 2-vinylpyridine and 4-vinylpyridine, such as
   2-vinyl-1-(3-sulfopropyl)pyridinium betaine (2SPV or “SPV”), sold by Raschig under the name SPV:

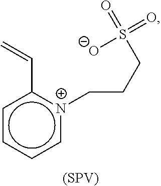

4-vinyl-1-(3-sulfopropyl)pyridinium betaine (4SPV), the synthesis of which is described in the paper “Evidence of ionic aggregates in some ampholytic polymers by transmission electron microscopy”, V. M. Castaño, A. E. González, J. Cardoso, O. Manero and V. M. Monroy, J. Mater. Res., 5 (3), 654-657 (1990):

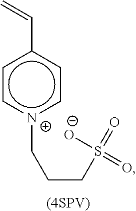

1-vinyl-3-(3-sulfopropyl)imidazolium betaine:

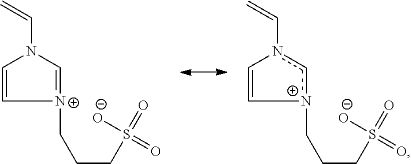

the synthesis of which is described in the paper “Aqueous solution properties of a poly(vinyl imidazolium sulfobetaine)”, J. C. Salamone, W. Volkson, A. P. Olson and S. C. Israel, Polymer, 19, 1157-1162 (1978),
alkylsulfonates of dialkylammonioalkylallylics, such as sulfopropylmethyldiallylammonium betaine:

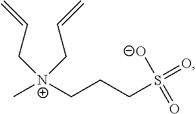

the synthesis of which is described in the paper “New poly(carbobetaine)s made from zwitterionic diallylammonium monomers”, Favresse, Philippe and Laschewsky, Andre, Macromolecular Chemistry and Physics, 200(4), 887-895 (1999),
alkylsulfonates of dialkylammonioalkylstyrenes, such as:

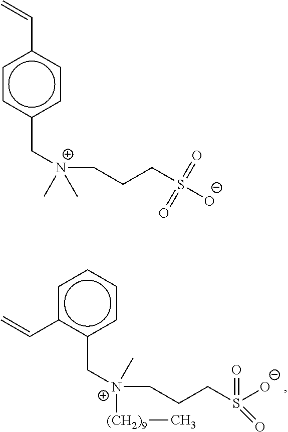

the synthesis of which is described in the paper “Hydrophobically Modified Zwitterionic Polymers: Synthesis, Bulk Properties, and Miscibility with Inorganic Salts”, P. Koberle and A. Laschewsky, Macromolecules, 27, 2165-2173 (1994),
betaines resulting from ethylenically unsaturated anhydrides and dienes, such as:

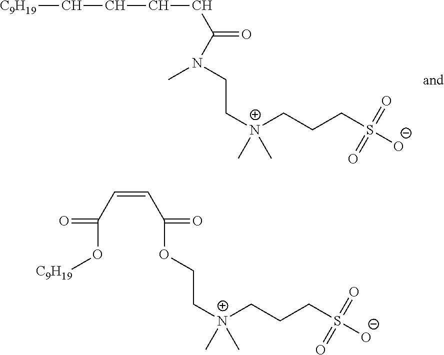

the synthesis of which is described in the paper “Hydrophobically Modified Zwitterionic Polymers: Synthesis, Bulk Properties, and Miscibility with Inorganic Salts”, P. Koberle and A. Laschewsky, Macromolecules, 27, 2165-2173 (1994),
betaines resulting from cyclic acetals, preferably ((dicyanoethanolate)ethoxy)dimethylammoniopropylmethacrylamide.

The polymer according to the invention can also be obtained in a known way by chemical modification of a polymer (copolymer), referred to as precursor polymer, comprising units A_{precursor} which will be modified (betainized) by postpolymerization reaction to give units A exhibiting a betaine group. Thus, sulfobetaine units can be obtained by chemical modification of units of a precursor polymer, preferably by chemical modification of a polymer comprising pendant amine functional groups, using a sulfonated electrophilic compound, preferably a sultone (propanesultone or butanesultone) or a haloalkylsulfonate.

A few synthetic examples are given below:

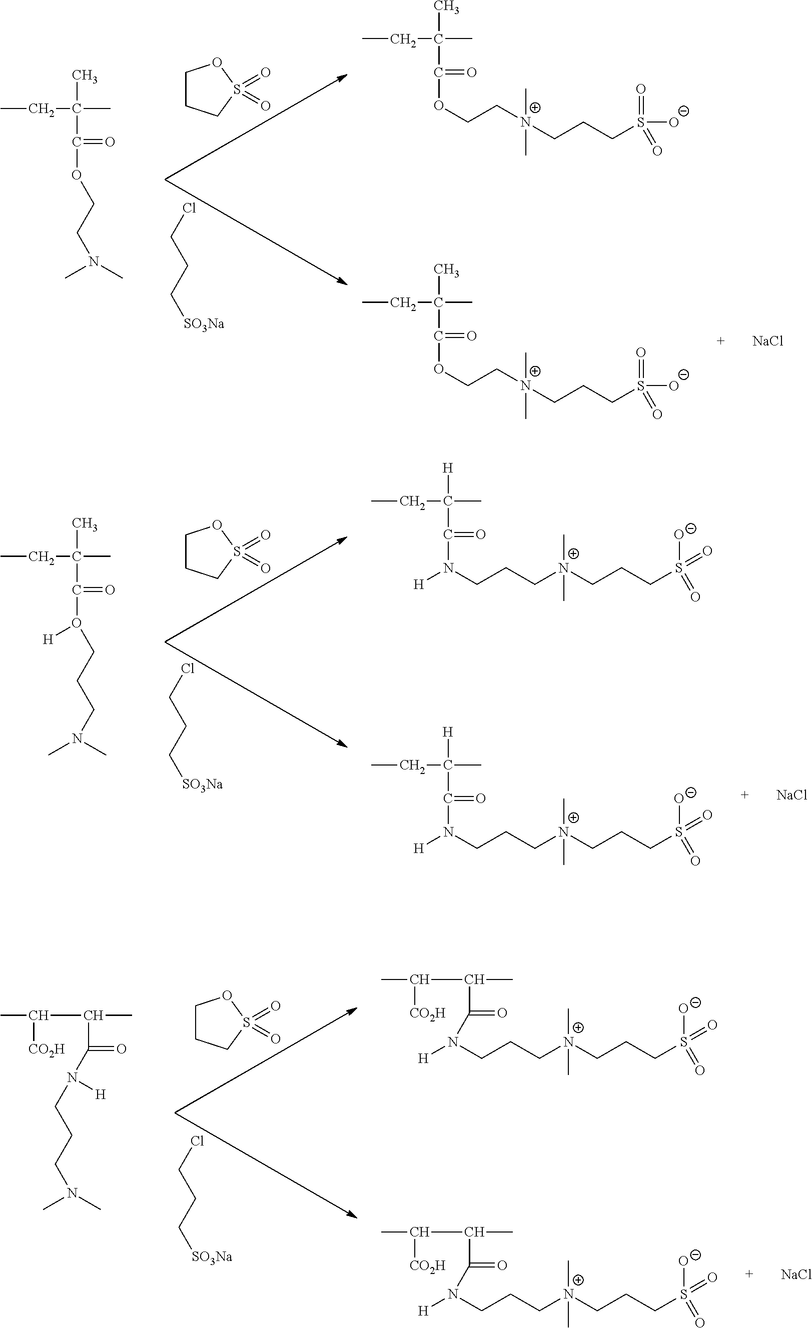

The main routes of access by chemical modification of a precursor polymer by sultones and haloalkylsulfonates are described in particular in the following documents:
“Synthesis and aqueous solution behavior of copolymers containing sulfobetaine moieties in side chains”, I. V. Berlinova, I. V. Dimitrov, R. G. Kalinova, N. G. Vladimirov, Polymer, 41, 831-837 (2000)
“Poly(sulfobetaine)s and corresponding cationic polymers: 3. Synthesis and dilute aqueous solution properties of poly(sulfobetaine)s derived from styrene-maleic anhydride”, Wen-Fu Lee and Chun-Hsiung Lee, Polymer, 38 (4), 971-979 (1997)
“Poly(sulfobetaine)s and corresponding cationic polymers. VIII. Synthesis and aqueous solution properties of a cationic poly(methyl iodide quaternized styrene-N,N-dimethylaminopropyl maleamidic acid) copolymer”, Lee, Wen-Fu and Chen, Yan-Ming, Journal of Applied Polymer Science, 80, 1619-1626 (2001)
“Synthesis of polybetaines with narrow molecular mass distribution and controlled architecture”, Andrew B. Lowe, Norman C. Billingham and Steven P. Armes, Chem. Commun., 1555-1556 (1996)
“Synthesis and Properties of Low-Polydispersity Poly(sulfopropylbetaine)s and Their Block Copolymers”, Andrew B. Lowe, Norman C. Billingham and Steven P. Armes, Macromolecules, 32, 2141-2146 (1999)
Japanese patent application published on Dec. 21, 1999 under the number 11-349826.

According to a preferred embodiment, the units A exhibit one of the following formulae:

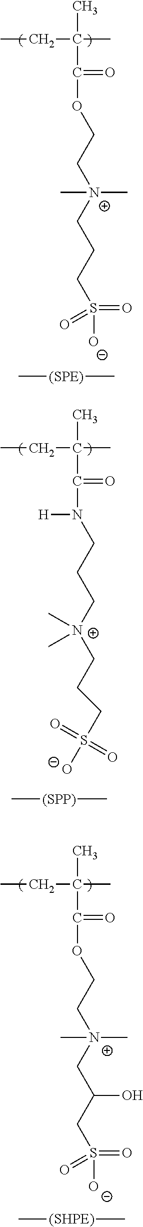

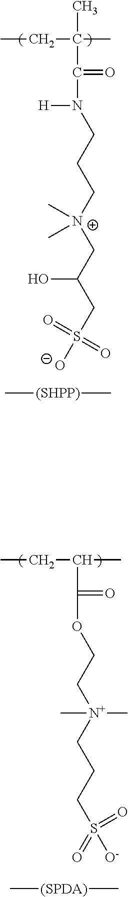

Units B

The units B are units deriving from vinylpyrrolidone. Such monomers are known. It is specified that N-vinylpyrrolidone is preferably concerned.

Specific Compositions of the Copolymer

The copolymer of the invention can comprise optional units Cₒₜₕₑᵣ which are different from the units A and B mentioned above. The units A and B can represent from 1 to 100 mol %, preferably from 50 to 100 mol %, preferably from 75 to 100 mol %, of the units of the copolymer.

According to a specific embodiment, the copolymer comprises:
from 1 to 25 mol % of the units A, preferably from 3 to 13%, and
from 75 to 99 mol % of the units B, preferably from 87 to 97%.

According to a specific embodiment, the molar ratio of the units A to the units B is between 1/99 and 25/75, preferably between 5/95 and 15/85.

The copolymer can in particular comprise, as units Cₒₜₕₑᵣ:
hydrophilic or hydrophobic nonionic units C_{N}, and/or
anionic or potentially anionic units C_{A}, and/or
cationic or potentially cationic units C_{C}.

According to an advantageous form, the copolymer does not comprise more than 25 mol % in total of such units and preferably does not comprise any at all. According to an advantageous form, the copolymer does not comprise more than 25 mol % in total of units C_{N} and preferably does not comprise any at all. According to an advantageous form, the copolymer does not comprise more than 25 mol % in total of units C_{A} and preferably does not comprise any at all. According to an advantageous form, the copolymer does not comprise more than 25 mol % in total of units C_{C} and preferably does not comprise any at all.

According to specific embodiments, the copolymer is substantially devoid (it comprises less than 1 mol %, preferably less than 0.5 mol %, thereof and preferably does not comprise any at all thereof) of the following units:
units C_{C}, and/or
units C_{N} chosen from:
   alkoxylated units of following formula:

—CH₂—CHR⁶[—X²—(CH₂—CH₂—O)ₙ—R⁷]—
in which:
   R⁶ is a hydrogen atom or a methyl group,
   X² is a group of formula —CO—O—, —CO—NH— or —C₆H₄—CH₂—
   n is a whole or mean number of greater than or equal to 1,
   R⁷ is a hydrogen atom, an alkyl group or a tristyrylphenyl group, and/or
hydroxylated units of following formula:

—CH₂—CHR⁶[—X²—R⁸]—
in which:
   R⁶ is a hydrogen atom or a methyl group,
   X² is a group of formula —CO—O—, —CO—NH— or —C₆H₄—CH₂—
   R^{B} is a hydrocarbon group having at least two carbon atoms which comprises at least two —OH groups, preferably on two consecutive carbon atoms, and/or
hydroxyalkyl acrylate or methacrylate units,
hydrophobic C_{N} units.

It is mentioned that the copolymer can be provided in any practical form, for example in the dry solid form or in the vectorized form, for example in the form of a solution or of an emulsion or of a suspension, in particular in the form of an aqueous solution. The vectorized form, for example an aqueous solution, can in particular comprise from 5 to 50% by weight of the copolymer, for example from 10 to 30% by weight. The aqueous solution can in particular be a solution obtained by an aqueous-phase preparation process, in particular a radical polymerization process.

The polymer of the invention can in particular exhibit a molar mass ranging from 20 000 g/mol to 1 000 000 g/mol, preferably from 100 000 g/mol to 400 000 g/mol.

Process for the Preparation of the Copolymer

The copolymer of the invention can be prepared by any appropriate process. The process will generally comprise a stage of radical polymerization (copolymerization), where monomers and a source of free radicals are brought together.

According to one embodiment, a mixture of monomers A_{precursor} and of vinylpyrrolidone is polymerized (copolymerization) in the presence of a source of free radicals, in order to obtain a copolymer comprising units B and units deriving from the monomers A_{precursor} and then these units are chemically modified in order to obtain units A (postpolymerization modification). Modifications were mentioned above, in the part which relates to the units A.

According to a preferred embodiment, the process comprises a stage of copolymerization by bringing together:
a monomer A (or A_{precursor}) comprising an ethylenically unsaturated group and a sulfobetaine group,
vinylpyrrolidone, and
a source of free radicals.

The radical polymerization processes are known to a person skilled in the art. In particular, the source of free radicals, the amount of free radicals, the steps for introducing the various compounds (monomers, source of free radicals, and the like), the polymerization temperature and other operating parameters or conditions can be varied in a known and appropriate way. A few details or instructions are given below.

The processes can be processes of batch type, of semibatch type or even of continuous type. A process of semibatch type typically comprises a step of gradual introduction of at least one monomer (comonomer), preferably of all the monomers (comonomers), into a reactor, without continuous departure of the reaction product, the reaction product, comprising the polymer, being recovered all at once at the end of the reaction.

It is noted that the polymerization can advantageously be carried out in aqueous solution.

Any source of free radicals can be used. It is possible in particular to generate free radicals spontaneously, for example by increasing the temperature, with appropriate monomers, such as styrene. It is possible to generate free radicals by irradiation, in particular by UV irradiation, preferably in the presence of appropriate UV-sensitive initiators. It is possible to use initiators or initiator systems of radical or redox type. The source of free radicals may or may not be water-soluble. It may be preferable to use water-soluble initiators or at least partially water-soluble initiators (for example, soluble in water to at least 50% by weight).

Generally, the greater the amount of free radicals, the more easily the polymerization is initiated (it is promoted) but the lower the molecular weights of the copolymers obtained.

Use may in particular be made of the following initiators:
hydrogen peroxides, such as: tert-butyl hydroperoxide, cumene hydroperoxide, t-butyl peroxyacetate, t-butyl peroxybenzoate, t-butyl peroxyoctoate, t-butyl peroxyneodecanoate, t-butyl peroxyisobutyrate, lauroyl peroxide, t-amyl peroxypivalate, t-butyl peroxypivalate, dicumyl peroxide, benzoyl peroxide, potassium persulfate or ammonium persulfate,
azo compounds, such as: 2,2′-azobisisobutyronitrile, 2,2′-azobis(2-butanenitrile), 4,4′-azobis(4-pentanoic acid), 1,1′-azobis(cyclohexanecarbonitrile), 2-(t-butylazo)-2-cyanopropane, 2,2′-azobis{2-methyl-N-[1,1-bis(hydroxymethyl)-2-hydroxyethyl]propionamide}, 2,2′-azobis[2-methyl-N-(hydroxyethyl)propionamide], 2,2′-azobis(N,N′-dimethyleneisobutyramidine)dichloride, 2,2′-azobis(2-amidinopropane)dichloride, 2,2′-azobis(N,N′-dimethyleneisobutyramide), 2,2′-azobis{2-methyl-N-[1,1-bis(hydroxymethyl)-2-hydroxyethyl)propionamide}, 2,2′-azobis{2-methyl-N-[1,1-bis(hydroxymethyl)ethyl]propionamide}, 2,2′-azobis[2-methyl-N-(2-hydroxyethyl)propionamide] or 2,2′-azobis(isobutyramide)dihydrate,
redox systems comprising combinations, such as:
mixtures of hydrogen peroxide, alkyl peroxide, peresters, percarbonates and the like and of any iron salt, titanous salt, zinc formaldehydesulfoxylate or sodium formaldehydesulfoxylate, and reducing sugars,
alkali metal or ammonium persulfates, perborates or perchlorates, in combination with an alkali metal bisulfite, such as sodium metabisulfite, and reducing sugars, and
alkali metal persulfates in combination with an arylphosphinic acid, such as benzenephosphonic acid and others of a like nature, and reducing sugars.

The polymerization temperature can in particular be between 25° C. and 95° C. The temperature can depend on the source of free radicals. If it is not a source of UV initiator type, it will be preferable to operate between 50° C. and 95° C., more preferably between 60° C. and 80° C. Generally, the higher the temperature, the more easily the polymerization is initiated (it is promoted) but the lower the molecular weights of the copolymers obtained.

Composition for Cleaning Dishes

The copolymer of the invention can be used in particular in a composition for cleaning dishes, automatically or by hand. Such compositions are known. The compositions can in particular comprise at least one surfactant. The compositions for cleaning dishes automatically generally comprise, in addition, a builder.

It is specified that the compositions and processes for cleaning dishes do not include the compositions and processes for cleaning hard surfaces other than dishes (cutlery, plates, dishes, kitchen utensils, containers, saucepans, frying pans, and the like). They do not include compositions and processes for cleaning hard surfaces, such as domestic, industrial and/or institutional surfaces, for example floors, walls, windows, sinks, furniture, toilets, kitchen walls or bathroom walls.

The composition for cleaning dishes can in particular comprise from 0.01 to 5% by weight, preferably from 0.05 to 3% by weight, preferably from 0.2 to 1.5% by weight, of the copolymer of the invention.

The composition can be provided in any form, in particular in the aqueous or nonaqueous liquid form, which is preferably concentrated, in the solid form or in the gel form.

The composition can be capable of foaming in an aqueous medium. It preferably comprises at least one surface-active agent (S) chosen from anionic surface-active agents, nonionic surface-active agents, amphoteric or zwitterionic surface-active agents, cationic surface-active agents or their mixtures. The amount of surface-active agent (S), expressed on a dry basis, can represent from 0.1 to 99%, preferably from 0.5 to 60%, of the total weight of composition.

When the detergent composition is a solid of cake of soap type, the amount of surface-active agent (S), expressed on a dry basis, can represent up to 99%, preferably up to 95%, of the total weight of composition; this amount usually represents at least 50% of the total weight of composition. The solids of cake of soap type can additionally comprise water and/or a water-compatible solvent in an amount which can range up to 20% of the weight of said solid.

Total weight of composition is understood to mean the weight of the whole of the composition including, in addition to the copolymer of the invention and optionally the surface-active agent (S), the other possible constituents (water, solvents, other additives).

Mention may in particular be made, as example of anionic surface-active agent, of:
alkyl ester sulfonates of formula R—CH(SO₃M)-COOR′, where R represents a C₈₋₂₀, preferably C₁₀-C₁₆, alkyl radical, R′ represents a C₁-C₆, preferably C₁-C₃, alkyl radical and M represents an alkali metal (sodium, potassium or lithium) cation, a substituted or unsubstituted ammonium (methyl-, dimethyl-, trimethyl- or tetramethylammonium, dimethylpiperidinium, and the like) cation or a cation derived from an alkanolamine (monoethanolamine, diethanolamine, triethanolamine, and the like). Mention may very particularly be made of methyl ester sulfonates in which the R radical is a C₁₄-C₁₆ radical;
α-olefin sulfonates comprising from 12 to 16 carbon atoms;
alkyl sulfates of formula ROSO₃M, where R represents a C₅-C₂₄, preferably C₁₀-C₁₈, alkyl or hydroxyalkyl radical and M represents a hydrogen atom or a cation with the same definition as above, and their ethoxylenated (EO) and/or propoxylenated (PO) derivatives, exhibiting on average from 0.5 to 30, preferably from 0.5 to 10, EO and/or PO units;
alkylamide sulfates of formula RCONHR′OSO₃M, where R represents a C₂-C₂₂, preferably C₆-C₂₀, alkyl radical, R′ represents a C₂-C₃ alkylene radical and M represents a hydrogen atom or a cation with the same definition as above, and their ethoxylenated (EO) and/or propoxylenated (PO) derivatives exhibiting on average from 0.5 to 60 EO and/or PO units;
salts of saturated or unsaturated C₈-C₂₄, preferably C₁₄-C₂₀, fatty acids, C₉-C₂₀ alkylbenzenesulfonates, primary or secondary C₈-C₂₂ alkylsulfonates, alkylglycerolsulfonates, the sulfonated polycarboxylic acids described in GB-A-1 082 179, paraffin sulfonates, N-acyl-N-alkyltaurates, alkyl phosphates, isethionates, alkylsuccinamates, alkyl sulfosuccinates, sulfosuccinate monoesters or diesters, N-acyl-sarcosinates, alkylglycoside sulfates, or polyethoxycarboxylates,

the cation being an alkali metal (sodium, potassium or lithium), a substituted or unsubstituted ammonium residue (methyl-, dimethyl-, trimethyl- or tetramethylammonium, dimethylpiperidinium, or the like) or a residue derived from an alkanolamine (monoethanolamine, diethanolamine, triethanolamine, or the like);
alkyl or alkylaryl phosphate esters, such as Rhodafac RA600, Rhodafac PA15 or Rhodafac PA23, sold by Rhodia.

The amount, expressed on a dry basis, of anionic surface-active agent (when it is present) can range from 0.5 to 90 parts by weight, preferably from 5 to 60 parts by weight, more particularly from 10 to 30 parts by weight, per 100 parts by total weight of composition.

Mention may in particular be made, among nonionic surface-active agents, of condensates of alkylene oxide, in particular of ethylene oxide, with alcohols, polyols or alkylphenols; fatty acid esters; fatty acid amides; fatty amines; amine oxides; sugar derivatives, such as alkylpolyglycosides or esters of fatty acids and of sugars, in particular sucrose monopalmitate; long-chain tertiary phosphine oxides; dialkyl sulfoxides; block copolymers of polyoxyethylene and of polyoxypropylene; polyalkoxylated sorbitan esters; fatty esters of sorbitan, poly(ethylene oxide)s and fatty acid amides modified so as to give them a hydrophobic nature for example, fatty acid mono- and diethanolamides comprising from 10 to 18 carbon atoms).

Mention may very particularly be made of:
polyoxyalkylenated (polyoxyethylenated, polyoxypropylenated or polyoxybutylenated) alkylphenols in which the alkyl substituent is a C₆-C₁₂ alkyl substituent and which comprise from 5 to 25 oxyalkylene units; mention may be made, by way of example, of Triton X-45, X-114, X-100 or X-102, sold by Rohm & Haas Co.;
glucosamides, glucamides or glycerolamides;
polyoxyalkylenated C₈-C₂₂ aliphatic alcohols comprising from 1 to 25 oxyalkylene (oxyethylene or oxypropylene) units. Mention may be made, by way of example, of Tergitol 15-S-9 or Tergitol 24-L-6 NMW, sold by Union Carbide Corp., Neodol 45-9, Neodol 23-65, Neodol 45-7 or Neodol 45-4, sold by Shell Chemical Co., or Rhodasurf ID060, Rhodasurf LA90 or Rhodasurf IT070, sold by Rhodia;
amine oxides, such as (C₁₀-C₁₈ alkyl)dimethylamine oxides or (C₈-C₂₂ alkoxy)ethyldihydroxyethylamine oxides;
the alkylpolyglycosides described in U.S. Pat. No. 4,565,647;
optionally polyhydroxylated C₈-C₂₀ fatty acid amides;
ethoxylated fatty acids;
ethoxylated amines.

The nonionic surface-active agents, when they are present, can represent from 0.1 to 20%, preferably from 0.1 to 15%, more particularly from 0.5 to 10% (on a dry basis), of the total weight of said composition.

Besides the anionic and/or nonionic surface-active agent or agents, one or more cationic, amphoteric or zwitterionic surface-active agents can additionally be present in the detergent composition.

Cationic surface-active agents are in particular alkylammonium salts of formula:

R¹R²R³R⁴N⁺X⁻

where:
X⁻ represents a halide, CH₃SO₄⁻ or C₂H₅SO₄⁻ ion,
R¹ and R² are alike or different and represent a C₁-C₂₀ alkyl radical, an aryl radical or a benzyl radical,
R³ and R⁴ are alike or different and represent a C₁-C₂₀ alkyl radical, an aryl radical, a benzyl radical or an ethylene oxide and/or propylene oxide condensate (CH₂CH₂O)ₓ—(CH₂CHCH₃O)_{y}—H, where x and y range from 0 to 30 and are never simultaneously zero,

such as cetyltrimethylammonium bromide, Rhodaquat® TFR, sold by Rhodia.

Said cationic surface-active agents, when they are present, can represent up to 10%, preferably from 1 to 5%, on a dry basis, of the total weight of said composition.

Examples of zwitterionic surface-active agents comprise aliphatic quaternary ammonium derivatives, in particular 3-(N,N-dimethyl-N-hexadecylammonio)propane-1-sulfonate and 3-(N,N-dimethyl-N-hexadecylammonio)-2-hydroxypropane-1-sulfonate.

Examples of amphoteric surface-active agents comprise betaines, sulfobetaines and carboxylates and sulfonates of fatty acids and of imidazole.

Preference is given to the following surfactants:
alkyldimethyl betaines, alkylamidopropyldimethyl betaines, alkyldimethyl sulfobetaines or alkylamidopropyldimethyl sulfobetaines, such as Mirataine CBS, sold by Rhodia, or condensation products of fatty acids and of protein hydrolysates;
alkyl amphoacetates or alkyl amphodiacetates, the alkyl group of which comprises from 6 to 20 carbon atoms;
amphoteric alkylpolyamine derivatives, such as Amphionic XL®, sold by Rhodia, or Ampholac 7T/X® and Ampholac 7C/X® sold by Berol Nobel.

The compositions for cleaning dishes by hand can additionally comprise additives for modifying the foam, in particular agents which improve the feel, the density and/or the whiteness of the foam, agents which increase the lifetime of the foam and/or agents which increase the amount of foam. In some cases, the term foam enhancers or foam boosters is used. They can, for example, be aliphatic alcohols (AA), preferably linear aliphatic alcohols, for example C₈-C₂₂, preferably C₁₂-C₁₈, more particularly C₁₂-C₁₆, alcohols, or their mixtures, which are described in the document WO 2006/035154. They can also be (co)polymers, for example described in the documents WO 00/71651, WO 00/71591, WO 02/026844, U.S. Pat. No. 6,656,900, EP 1 180 061, WO 99/27058, WO 99/27054, WO 99/27053, WO 99/27057, WO 00/71660, WO 00/71659, WO 00/71241, WO 00/71652 and WO 00/71656.

Preferably, the composition additionally comprises water and/or at least one water-compatible solvent. Water-compatible solvent is understood to mean any solvent which, as a mixture with water, forms, at ambient temperature, a single transparent phase. The water and/or the solvent can represent up to 99.5% of the total weight of said composition; the minimum amount of water and/or water-compatible solvent is usually 1%. When a water/solvent mixture is concerned, said solvent can represent up to 80% of the weight of said mixture. Said solvent is preferably chosen from aliphatic C₂-C₈ mono- or polyalcohols, and their ethers. Mention may in particular be made, as examples of solvents, of ethanol, propanol, isopropanol, butanol, 2-butoxyethanol, diethylene glycol, 1-butoxyethanol-2-propanol or diethylene glycol monobutyl ether.

Said composition, in particular when it is a concentrated liquid composition, can additionally comprise at least one polymer for controlling the viscosity and/or the stability of the foams, such as polyacrylic acids or their water-soluble salts exhibiting a weight-average molecular weight of 1000 to 5 000 000 g/mol, ethylene oxide/propylene oxide block copolymers with a weight-average molecular weight of up to 30 000 g/mol, polyethylene glycols having a molecular weight of at least 400 g/mol or biopolymers having a molecular weight of at least 10 000 g/mol; when it is present, said polymer can represent from 0.01 to 10% of the weight, on a dry basis, of the concentrated liquid composition.

Concentrated composition is understood to mean any composition capable of being diluted during use.

Mention may be made, as examples of polymers capable of controlling the viscosity and/or the stability of the foams, of:
polyacrylic acids or their salts, such as the Carbopol products from B.F. Goodrich, in particular Carbopol 941, Carbopol 801, Carbopol 907, Carbopol 910, Carbopol 934 or Carbopol 940,
ethylene oxide/propylene oxide block copolymers, such as the Antarox products from Rhodia, in particular Antarox F-88,
biopolymers, such as guar gum, gum arabic, xanthan gum, rheozan gum, welan gum, carrageenans, or cellulose derivatives or guar derivatives (carboxymethyl cellulose, hydroxyethyl cellulose, hydroxypropyl guar, carboxymethyl guar or carboxymethyl hydroxypropyl guar).

Whitening agents, builders, hydrotropic agents, moisturizing agents, fragrances, biocides, preservatives and other normal additives can also be present, according to the destination of the composition.

Mention may in particular be made, as regards the compositions for washing dishes by hand, of:
synthetic cationic polymers, such as Mirapol A550® or Mirapol A15®, sold by Rhodia, or Merquat 550®, sold by Calgon,
hydrotropic agents, such as short C₂-C₈ alcohols, in particular ethanol, diols and glycols, such as diethylene glycol or dipropylene glycol,
moisturizing or humectant agents for the skin, such as glycerol, urea or skin-protecting agents, such as proteins or protein hydrolysates, or cationic polymers, such as cationic guar derivatives (Jaguar C13S®, Jaguar C162® or Hicare 1000®, sold by Rhodia).

It is noted that the compositions can be diluted at the time of their use; the latter can be diluted from 10 to 50 000 times their volume, according to their destination. Their concentration of surface-active agents, after dilution, can generally reach from 0.0001 to 10%, preferably from 0.001 to 5%, very particularly from 0.005 to 2%.

Use of the Composition—Drying

The composition for cleaning dishes can be used normally.

In the context of a process for cleaning dishes by hand, a process comprising the following stages can, for example, be carried out:

Stage a) optionally diluting the composition in water,

Stage b) bringing together the dishes item to be cleaned and the optionally diluted composition, if appropriate using an application means,

Stage c) generally rubbing the dishes using a rubbing means,

Stage d) optionally rinsing the dishes,

Stage e) drying.

The process for cleaning dishes can vary according to the individual.

Stage a) can correspond to the formation of a dishes bath. The degree of dilution can typically be from 100 to 2000. A “full sink” process is sometimes referred to. In such an embodiment, the concentration of copolymer of the invention can in particular be from 0.00025% to 0.01%, preferably from 0.0001 to 0.005%. The degree of dilution can be adapted to this end. In particular, it can be stipulated by any communication means related to the product, for example on the label, in an advertisement, via a customer service department or via an internet site. A degree of diluting can be carried out during the application of the composition to an appropriate application and/or rubbing means comprising water, such as a sponge impregnated with water or with an aqueous composition or a nonwoven pad. In such an embodiment, the concentration of copolymer of the invention (after diluting) can in particular be from 1 to 100.

Stage b) can in particular be carried out by dipping the dishes item in a dishes bath. According to another form, the composition is applied directly to the dishes item, for example by pressure on a flexible or semi-flexible container comprising the composition, or using a pump, or by simple gravity. According to another form, the composition is applied to an application means, such as a sponge, a pad, a brush or the fingers of the person doing the dishes, optionally protected by gloves, and then the application means is brought into contact with the dishes item. For both these latter forms, a direct application process is often referred to. It is noted that a degree of diluting can then occur, stage a) and stage b) then being simultaneous and/or joined together.

The process of direct application type may be preferred and may provide a more significant improvement in the drying. In particular, it can be stipulated by any communication means related to the product, for example on the label, in an advertisement, via a customer service department or via an internet site.

Stage c) of rubbing can in particular be carried out conventionally, by circular movements and/or to-and-fro movements of the rubbing means over the dishes item. The rubbing means can, for example, be a sponge, a pad, a brush or the fingers of the person doing the dishes, optionally protected by gloves. It can in addition be the application means of stage b). The contacting operation can be carried out while rubbing; stage b) and stage c) are then joined together.

Stage d) is generally recommended. It can be carried out conventionally, for example by dipping in clean water (the dishes item is subsequently taken out) or by passing under a flow of water.

Stage e) can be carried out conventionally. During this stage, the dishes will simply be left to dry, if appropriate on a drain board, or a dish towel or any other device promoting the removal and/or absorption of water.

Other details or advantages of the invention may become apparent in the light of the examples which follow, without limiting nature:

### EXAMPLE 1

### Preparation of Copolymers

### EXAMPLE 1.1

### Copolymer Formed of 90 Mol % of Vinylpyrrolidone and 10 Mol % of SPE

32.2 g of water are added to a 500 ml three-necked round-bottomed glass flask equipped with a mechanical stirrer, a reflux condenser and an oil bath for regulating the temperature. The temperature of the reaction medium is brought to 75° C. while flushing with nitrogen. 0.11 g of 2,2′-azobis(2-methylpropionamidine)dihydrochloride, dissolved in 0.6 g of water, is added at 75° C. A solution comprising 82.1 g of N-vinylpyrrolidone, 22.9 g of SPE and 195 g of water and another solution comprising 1 g of 2,2′-azobis(2-methylpropionamidine)dihydrochloride and 20 g of water are subsequently added simultaneously over 4 h and 5 h respectively. At the end of these additions, stirring and the temperature are maintained over 4 h. The reaction medium is subsequently cooled to ambient temperature.

### EXAMPLE 2

### Formulation in a Liquid for the Dishes by Hand and Evaluation of the Rate of Drying

Evaluation Protocol

Objective: to estimate the quality of drying of a kitchen glass which is taken out of a basin of rinsing water.

Principle: a kitchen glass is washed by hand using the formulation to be evaluated, rinsed and dipped in a basin of water at 40° C. With the aim of facilitating the visualization of the residual traces of water after complete drying of the glass, this dipping is carried out in water of very high hardness. For convenience, use is made of commercial Contrex® mineral water.

The glass, laden with water on removing from the basin, is deposited on a support placed on a balance.

The weight of the glass is recorded while the water flows out, in order to obtain the weight of water remaining on the glass as a function of the time and thus the drying profile of said glass.

Device: a metal rod-support (2), the top end of which is slightly beveled, is placed on the balance (4).

A large funnel (3), inverted, covers the balance without touching the plate. The rod passes through the tube of the funnel.

The kitchen glass (1) will be hung upside-down on the end of the rod-support.

The only point of contact is on the bottom of the glass, inside. As the end is beveled, the glass tilts, so as to facilitate the flow of the water at one point. The water flows onto the funnel. The balance measures the loss in weight of the glass.

The acquisition of the measurements takes place automatically (connection of the balance to a computer via an RS232 port) via a Microsoft® Excel routine. Generally, one reading is taken per second, over a period of approximately 200 seconds.

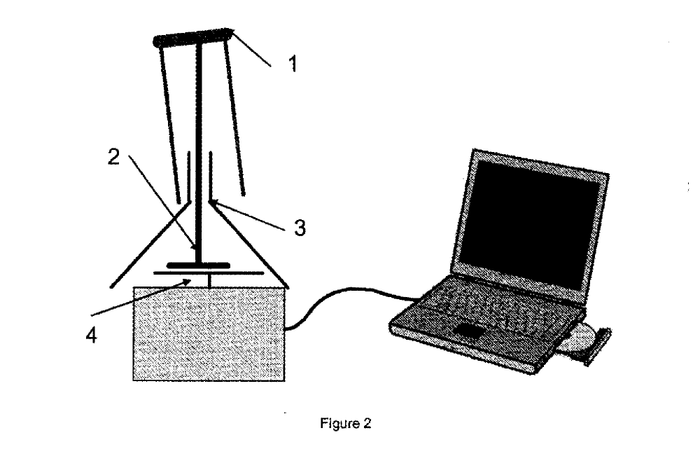

A diagram of the device is presented in FIG. 2.

Procedure:

Put on the laboratory gloves.

Take a clean glass.

Tare the balance.

Place the glass on the rod-support.

Determine its weight: “dry glass”.

Put 3 liters of Contrex® water to be heated in a thermostatically controlled bath (40° C.).

Cut off a piece of sponge (sides of approximately 4 cm).

Run the faucet water at 40° C.

Wet the sponge and then wring it out.

Deposit the formulation to be evaluated on top of it (1 ml).

Squeeze the sponge several times in the hand in order to bring about copious foaming.

Rub the glass over all the faces with the sponge full of foam.

Rinse with hot water (40° C.). Thoroughly rinse the gloves.

Immerse in Contrex® water at 40° C.

Tare the balance.

Start the acquisition and simultaneously take the glass out of the thermostatically controlled bath in order to place it on the rod.

The sides of the glass must not touch the funnel in order not to falsify the weighing.

At 180 seconds:
Stop the acquisition.
Wipe off the water on the bottom and the sides of the glass.
Tare the balance without the glass.
Measure the “final weight” of the glass.

Exploitation of the Results:

The weight of the dry glass and the weight of water wiped off (weight at 180 s—final weight) have to be subtracted from the measurements of weights recorded.

A curve of the loss of water as a function of the time is obtained.

### EXAMPLE 2.1 (COMPARATIVE)

### Washing the Glass with a Commercial Formulation: Palmolive® Sensitive Skin

A drinking glass is washed according to the protocol described above with a commercial dishwashing formulation: Palmolive® Sensitive Skin, sold in France by Colgate-Palmolive.

It is found visually during the experiment that the glass remains covered for more than 150 seconds with a homogeneous film of water which only appears to disappear with the evaporation of the residual water.

The weight of water remaining on the glass is read as a function of the time according to the above protocol.

The following drying profile is obtained:

| Time (s) | Weight (g) |
|---|---|
| 10 | 1.517 |
| 20 | 0.957 |
| 30 | 0.799 |
| 40 | 0.616 |
| 50 | 0.564 |
| 60 | 0.514 |
| 70 | 0.482 |
| 80 | 0.445 |
| 90 | 0.429 |
| 100 | 0.409 |
| 110 | 0.393 |
| 120 | 0.387 |
| 130 | 0.375 |
| 140 | 0.24 |
| 150 | 0.232 |
| 160 | 0.229 |
| 170 | 0.218 |

It is found that, after 170 seconds, 0.218 g of water remains on the glass. This water is distributed over the surface in a fairly homogeneous way, in the form of a very thin film.

After complete drying of the glass by evaporation of the residual water, the presence of a film of limescale covering a large part of the surface is found by observing this glass through a direct light (sunlight or light of a lamp). This deposit originates from the evaporation of the Contrex® water, which water has a hardness in the vicinity of 156 French TH degrees.

### EXAMPLE 2.2

### Washing the Glass with a Formulation Comprising the Copolymer According to the Invention

A liquid formulation for dishes is prepared in the following way:

0.5 g (as weight of dry polymer) of the copolymer of example 1.1 is added to 100 g of the commercial formulation Palmolive® Sensitive Skin.

The experiment carried out in example 2.1 is then repeated and the following drying profile is obtained:

| Time (s) | Weight (g) |
|---|---|
| 10 | 1.595 |
| 20 | 1.126 |
| 30 | 0.872 |
| 40 | 0.608 |
| 50 | 0.381 |
| 60 | 0.279 |
| 70 | 0.178 |
| 80 | 0.076 |
| 90 | 0.074 |
| 100 | 0.068 |
| 110 | 0.063 |
| 120 | 0.059 |
| 130 | 0.05 |
| 140 | 0.049 |
| 150 | 0.045 |
| 160 | 0.042 |
| 170 | 0.037 |

It is found that, after an initial phase of approximately 40 s during which the weights of residual water on the glasses are identical, with and without polymer, the weight of water remaining on the glass modified by the copolymer becomes significantly lower than on the unmodified glass. Slow and homogeneous dewetting of the film of water on the surface of the glass is observed. This process begins via the top of the glass and goes down in order finally to spread slowly towards the bottom of the glass, without leaving a significant number of drops on the surface.

After 170 seconds, only 0.037 g of water remains on the glass, markedly less than on the glass washed without polymer (example 1).

After complete drying of the glass, a noteworthy transparency and the absence of limescale film, with the exception of a few residual spots, is found by observing this glass through a direct light (sunlight or light of a lamp).

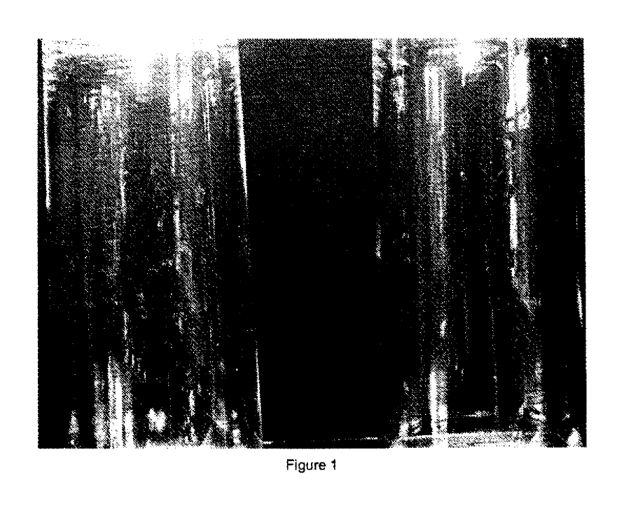

FIG. 1 exhibits a photograph with:
on the left, a glass obtained after washing and drying according to example 2.1 (comparative)
on the right, a glass obtained after washing and drying according to example 2.2 in accordance with the invention.

In these photographs, the vertical white features are reflections due to the illumination. It is seen that the left-hand photograph (comparative) exhibits numerous more or less circular traces of drying, in contrast to the right-hand photograph.

1-13. (canceled)

14. A copolymer comprising zwitterionic units A and units B, wherein
units A comprise a sulfobetaine group, and
units B comprise units deriving from vinylpyrrolidone.

15. The copolymer of claim 14, wherein the units A and B represent from 1 to 100 mol % of the units of the copolymer.

16. The copolymer of claim 15, wherein the units A and B represent from 50 to 100 mol % of the units of the copolymer.

17. The copolymer of claim 14, wherein said copolymer comprises:
from 1 to 25 mol % of the units A, and
from 75 to 99 mol % of the units B.

18. The copolymer of claim 17, wherein said copolymer comprises:
from 3 to 13 mol % of the units A, and
from 87 to 97 mol % of the units B.

19. The copolymer of claim 14, wherein the molar ratio of the units A to the units B ranges from 1/99 to 25/75.

20. The copolymer of claim 19, wherein the molar ratio of the units A to the units B ranges from 5/95 to 15/85.

21. The copolymer of claim 14, wherein said copolymer additionally comprises:
hydrophilic or hydrophobic nonionic units C_{N},
anionic or potentially anionic units C_{A}, and/or
cationic or potentially cationic units C_{C}.

22. The copolymer claim 14, wherein said copolymer is a random copolymer.

23. The copolymer of claim 14, wherein the sulfobetaine group of the units A is a pendant group of the copolymer.

24. The copolymer of claim 14, wherein the units A and B, optionally with other units, form a polyalkylene hydrocarbon chain optionally interrupted by one or more nitrogen or sulfur atoms.

25. The copolymer of claim 14, wherein the sulfobetaine group derives from at least one betaine monomer A comprising:
alkylsulfonates of dialkylammonioalkyl acrylates, methacrylates, acrylamides, or methacrylamides;
heterocyclic betaine monomers;
alkylsulfonates of dialkylammonioalkylallylics,
alkylsulfonates of dialkylammonioalkylstyrenes
betaines deriving from ethylenically unsaturated anhydrides and dienes
betaines deriving from cyclic acetals;
betaines deriving from a chemical modification of units of a precursor polymer; or
mixtures thereof.

26. The copolymer of claim 25, wherein said alkylsulfonates of dialkylammonioalkyl acrylates, methacrylates, acrylamides, or methacrylamides comprise:
sulfopropyldimethylammonioethyl methacrylate,
sulfoethyldimethylammonioethyl methacrylate,
sulfobutyldimethylammonioethyl methacrylate,
sulfohydroxypropyldimethylammonioethyl methacrylate,
sulfopropyldimethylammoniopropylacrylamide,
sulfopropyldimethylammoniopropylmethacrylamide,
sulfopropyldiethylammonioethyl methacrylate,
sulfohydroxypropyldimethylammoniopropylmethacrylamide,
sulfohydroxypropyldiethylammonioethyl methacrylate, or
mixtures thereof.

27. The copolymer of claim 25, wherein said heterocyclic betaine monomers comprise:
sulfobetaines derived from piperazine;
sulfobetaines derived from 2-vinylpyridine and 4-vinylpyridine;
1-vinyl-3-(3-sulfopropyl)imidazolium betaine; or
mixtures thereof.

28. The copolymer of claim 27, wherein said heterocyclic betaine monomer comprises 2-vinyl-1-(3-sulfopropyl)pyridinium betaine, 4-vinyl-1-(3-sulfopropyl)pyridinium betaine, or mixtures thereof.

29. The copolymer of claim 25, wherein monomer A comprises sulfopropylmethyldiallylammonium betaine.

30. The copolymer of claim 25, wherein said betaines deriving from cyclic acetals comprise ((dicyanoethanolate)ethoxy)dimethylammoniopropylmeth-acrylamide.

31. The copolymer of claim 25, wherein said betaines deriving from a chemical modification of units of a precursor polymer comprise betaines deriving from a chemical modification of a polymer comprising pendant amine functional groups using a sulfonated electrophilic compound.

32. The copolymer of the claim 25, wherein the at least one monomer A comprises one of the compounds of the following formulae:

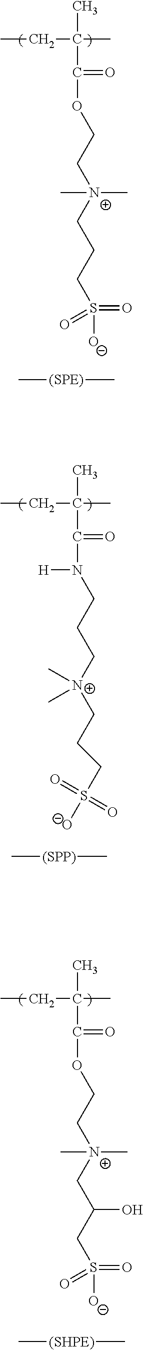

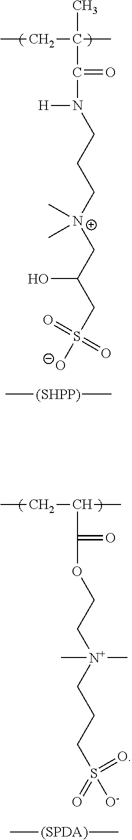

33. A process for the preparation of the copolymer of claim 14, comprising bringing together:
a monomer A comprising an ethylenically unsaturated group and a sulfobetaine group,
vinylpyrrolidone, and
a source of free radicals.

34. A method comprising cleaning dishes, automatically or by hand, with the composition of claim 14.

35. The method of claim 34, wherein said composition promotes slow dewetting and/or rapid and/or trace-free drying.
